(19) United States
(12) Patent Application Publication
(10) Pub. No.: US 2025/0210685 A1
(43) Pub. Date: Jun. 26, 2025

(54) Tightening System, Fuel Cell Assembly, Vehicle and Method for Producing a Fuel Cell Assembly

(71) Applicant: Bayerische Motoren Werke Aktiengesellschaft, Muenchen (DE)

(72) Inventors: Peter EICHINGER, Muenchen (DE); Stefan WEINDL, Holzkirchen (DE)

(21) Appl. No.: 18/852,005

(22) PCT Filed: Mar. 29, 2023
(86) PCT No.: PCT/EP2023/058152

§ 371 Date: Sep. 27, 2024

(30) Foreign Application Priority Data
Mar. 29, 2022 (DE) 10 2022 107 433.1

(51) Int. Cl. H01M 8/248; H01M 8/2404; H01M 8/2475

(52) U.S. Cl. CPC H01M 8/248; H01M 8/2404; H01M 8/2475; H01M 2250/20

(57) ABSTRACT

A tensioning system for a fuel cell stack includes a pressure plate with a contact surface for bearing against the fuel cell stack, a tensioning element which is arranged on a side of the pressure plate which is opposed to the contact surface, at least one spring element which is arranged between the pressure plate and the tensioning element and has a spring axis, along which the at least one spring element can be tightened, and at least one tensioning device. The tensioning device is designed to exert a pressure force on the tensioning element. The pressure force is directed along the spring axis and in the direction of the pressure plate. The tensioning element is configured to transmit the pressure force with pre-tightening of the at least one spring element to the pressure plate.

### BACKGROUND AND SUMMARY

The technology disclosed herein relates to a tensioning system for a fuel cell stack, to a fuel cell assembly with the tensioning system, to a vehicle with the tensioning system or the fuel cell assembly, and to a method for producing a fuel cell assembly.

It is known for a plurality of fuel cells to be combined to form a fuel cell stack, in order to provide a compact energy converter which is suitable for mobile applications (in particular, for modern means of transport such as motor vehicles or aircraft). The individual fuel cells of the fuel cell stack make it possible here for chemical energy of a continuously supplied fuel to be converted directly into electrical energy. The fuel cells usually comprise an anode, a cathode and an eponymous electrolyte which is arranged between the anode and the cathode.

A polymer electrolyte membrane (PEM) fuel cell stack can have, for example, two end plates and a plurality of separator plates (monopolar plates or bipolar plates) between the end plates, wherein membrane electrode assemblies (what are known as MEAs) are in turn provided between the separator plates. The separator plates are provided with a usually meandering fluid duct for the fuel or the oxidizing agent. The membrane electrode assemblies generally in each case comprise a proton conducting membrane and electrodes which are arranged on both sides of the membrane and as a rule each have a catalytic layer and a porous gas diffusion layer.

In order to conduct the fuel/oxidizing agent (what are known as reaction fluids) in a targeted manner through the electrode stack and into the fluid ducts of the separator plates, the separator plates can contain passages. Together with sealing elements which are correspondingly provided between the separator plates, these passages can configure lines for the reaction fluids. In order that the sealing elements can develop their sealing action, it is beneficial to press the fuel cell stacks together (to brace them).

It is one preferred object of the technology disclosed herein to reduce or to eliminate at least one disadvantage of a previously known solution, or to propose an alternative solution. It is, in particular, one preferred object of the technology disclosed herein to provide a tensioning system which is as simple as possible and by way of which the fuel cell stack can be pressed together (braced) comparatively precisely. Moreover, it is one preferred object to provide a corresponding fuel cell assembly, a corresponding vehicle and a corresponding method for producing a fuel cell assembly. Further preferred objects can result from the advantageous effects of the technology disclosed herein.

This object/these objects is/are achieved by way of the subject matter of the independent claims. The dependent claims are preferred refinements.

The tensioning system is provided for a fuel cell stack. That is to say, the tensioning system serves as intended to press (to brace/clamp) a fuel cell stack together permanently parallel to its stack direction. The tensioning system comprises a pressure plate with a contact surface for bearing against the fuel cell stack, a tensioning element which is arranged on a side of the pressure plate which is opposite the contact surface, at least one spring element which is arranged between the pressure plate and the tensioning element and has a spring axis, along which the at least one spring element can be tensioned, and at least one tensioning device. The at least one tensioning device is designed to exert a pressure force on the tensioning element, which pressure force is directed along the spring axis and in the direction of the pressure plate. The tensioning element is configured to transmit the pressure force to the pressure plate with preloading of the at least one spring element.

This makes it possible for the pressure force, by way of which the tensioning system clamps the fuel cell stack together, to be distributed relatively uniformly over the contact area, in particular during assembly. Since the pressure force acts along the spring axis and, starting from the tensioning device, is transmitted via the tensioning element, the spring element and the pressure plate to the fuel cell stack, the tensioning system allows the operation of the bracing of the fuel cell stack to be automated comparatively simply. In particular, the pressure force can be regulated (what is known as force regulating), by way of which pressure force the fuel cell stack is pressed together during and after the production of a fuel cell assembly with the fuel cell stack. On account of the uniform distribution of forces, the individual fuel cells of the fuel cell stack can be sealed with respect to one another in an improved manner. In a synergistic way, moreover, the spring element can absorb, in particular, temperature-induced length changes of the fuel cell stack in the stack direction.

The tensioning element is preferably configured as a plate (what is known as a tensioning plate) or as a sleeve. Here, in accordance with a general definition in engineering mechanics, a plate is a component which extends in its (main) plane, comprises a rigid material, and can be loaded by way of forces which act perpendicularly on the plane and by way of torques about axes which lie in the plate plane. In order to make a direct, coaxial transmission of the pressure force from the tensioning device to the at least one spring element possible, the tensioning element/tensioning plate is therefore rigid, in particular more rigid than the at least one spring element. The sleeve can be a hollow-cylindrical body. The hollow-cylindrical body can have a length in the stack direction of at least 4 mm, preferably at least 5 mm. A center longitudinal axis of the hollow-cylindrical body can lie on the spring axis.

While the pressure plate is preferably configured congruently with respect to a surface of the fuel cell stack which faces the pressure plate, the tensioning element can have a smaller cross section perpendicularly with respect to the spring axis than the pressure plate. Accordingly, the pressure plate can protrude beyond the tensioning element in a consideration along the spring axis/parallel to the stack direction. The tensioning system can have a plurality of the spring elements per tensioning element.

For example, a tensioning element (in particular, a tensioning plate) can be arranged to press on a plurality of spring elements (in particular, spaced apart from one another transversely with respect to the spring axis). A plurality of, in particular, separate tensioning devices (in particular, tensioning nuts) can be arranged on the other side of the tensioning element which faces away from the pressure plate, in order to bear against one and the same tensioning element and/or to press on one and the same tensioning element. The pressure force can thus be adjusted comparatively simply and precisely. Here, precisely one tensioning plate and a plurality of tensioning devices and a plurality of spring elements which are spaced apart from one another can be provided per tensioning system and/or per fuel cell stack.

The at least one spring element is preferably configured as an (at least partially elastic) compression spring. In the present disclosure, in particular, the effective axis of the spring element in the case of use as intended is denoted as the spring axis. In other words, the spring axis is that axis, along which the spring element is compressed (preloaded), in order to press (to brace) the fuel cell stack together, in particular, parallel to the stack direction of the fuel cell stack. The spring axis can therefore run parallel to the stack direction. As a consequence, a longitudinal extent of the spring element parallel to the spring axis or parallel to the stack direction of the fuel cell stack can be greater in a non-compressed starting state than in the compressed end state which the spring element assumes when the fuel cell stack is braced by means of the tensioning system. Moreover, the spring element can be capable of being relieved automatically along the spring axis. That is to say, when the tensioning device reduces the magnitude of the pressure force which is exerted on the tensioning element, the spring element can expand automatically along the spring axis (and the stack direction) in its installed position between the pressure plate and the tensioning element.

In the context of the present disclosure, a pressure force can be understood to be the sum of all the part forces (force vectors) which the tensioning device exerts on the tensioning element. The pressure force (that is to say, the pressure force vector) can have its origin at the center of gravity of the tensioning device. As a consequence, the pressure force can also be oriented parallel (in particular, anti-parallel) to the stack direction of the fuel cell stack. In the present case, the tensioning element and the tensioning device serve to load the spring element against the pressure plate. It is conceivable here that the tensioning device is connected to the tensioning element fixedly, for example in an integrally joined manner.

The at least one spring element preferably is or comprises at least one cup spring. As an alternative, the spring element can be or comprise a spiral spring. In a further alternative, the spring element can comprise a body made from a resilient, in particular elastic, material, for example an elastomer. A plurality of spring elements of this type can be provided which can preferably be stacked on one another parallel to the spring axis. In one particularly preferred variant, the at least one spring element is a set of a plurality of cup springs stacked on one another along the spring axis (also called a cup spring set in the following text). Accordingly, the spring element/elements can each be of cylindrically symmetrical configuration, wherein the spring axis is the axis of symmetry of the spring elements. The tensioning device is preferably arranged coaxially (with the same axis) with respect to the spring element. That is to say, the pressure force preferably acts precisely on the spring axis. In other words, the origin of the vector of the pressure force preferably lies on the spring axis, and the direction of the vector of the pressure force is parallel to the spring axis.

The at least one spring element can be provided with a guide for guiding the tensioning element along the spring axis, in particular parallel to the spring axis. The guide can be configured in one piece with the spring element or as a separate component. In one preferred variant, the guide is configured without joints with the spring element. In this case, the guide and the spring element can together form a spring component which is preferably produced as a (plastic) cast part. In particular, the guide can be configured as a tubular portion. The tubular portion can likewise be of cylindrically symmetrical configuration here in relation to the spring axis. The guidance realized in this way of the tensioning element coaxially with respect to the spring element (that is to say, along the spring axis) makes a precise transmission of the pressure force from the tensioning element to the pressure plate possible. As a consequence, the tensioning system makes it possible in a simple and efficient way for the fuel cell stack to be braced relatively precisely in an automated manner.

The guide can run centrally through the spring element and can protrude beyond the spring element in the longitudinal direction of the tensioning system (along the spring axis) on the side of the pressure plate and/or on the side of the tensioning element. Accordingly, the guide can protrude into the pressure plate and/or the tensioning element, with the result that the tensioning system can be distinguished by a compact overall design. That portion of the guide which protrudes beyond the at least one spring element is most preferably received completely in the tensioning element. In particular, the guide can penetrate through the tensioning element. The tensioning element can be movable along the guide coaxially with respect to the spring element. In particular, the tensioning element can be mounted such that it slides on the guide along the spring axis. Conversely, in order to absorb an expansion of the fuel cell stack in the longitudinal direction (stack direction/along the spring axis), the guide can slide in the tensioning element relative to the tensioning element, in particular in a first depression which is configured in the tensioning element.

As explained below in detail, the tensioning system can make it possible for the fuel cell stack to be pressed together in an automated manner, in order to produce a fuel cell assembly with the fuel cell stack which is moved closer together. For this purpose, a production machine in the form of a (for example, pneumatic or hydraulic) press, in particular a ram press, can be used. This press can have at least one, preferably a plurality of, axially movable (along the spring axis, in particular) ram/rams as tool. Each ram can have a distal end which is provided to make contact with the tensioning element. An axial bearing can be configured (for instance as a plain bearing or a ball bearing) at the distal end. The press or at least the at least one ram can be part of the tensioning system. Statements made in the following text for the ram can apply to each of the rams.

The tensioning element can have a receptacle which can be open toward a side of the tensioning element which is opposite the pressure plate. This receptacle can be dimensioned here in such a way that the distal end of the ram fits into the receptacle. The ram can therefore be brought into engagement with the receptacle. In one preferred variant, the receptacle is of cylindrically symmetrical configuration, in particular as a cylindrically symmetrical hole. In this case, the spring axis is preferably an axis of symmetry of the receptacle. The receptacle can be configured as a blind hole. As an alternative, the receptacle can have a connecting opening to the first depression in the region of its base which faces the pressure plate. In other words, the tensioning element can be provided with a through hole which extends from a longitudinal end which faces away from the pressure plate and faces the tensioning device as far as a longitudinal end which faces the pressure plate and faces away from the tensioning device, through the tensioning element. This through hole can be formed through the receptacle and the first depression, and can taper at the transition between the receptacle and the first depression.

In order for it to be possible for the pressure force to be transmitted as precisely and uniformly as possible to the spring element, the tensioning element preferably has a base portion which is provided for making contact with the at least one spring element and the surface of which, which faces the pressure plate, is planar (flat). The spring element can be compressed continuously axially in this way, in particular if it is configured as a cup spring, without exerting a transverse force on the pressure plate. At least one sleeve-shaped elevation can extend away from the base portion on that side of the tensioning element which is opposite the pressure plate. Here, the receptacle for the ram can be configured in the elevation. The wall of this receptacle is therefore preferably cylindrically symmetrical; it preferably runs coaxially with respect to the spring element. The tensioning element can be configured as a whole without joints (monolithically), in particular as a cast part (for example, as a plastic cast part).

The pressure plate can be rigid or at least more rigid than the spring element, provided between the pressure plate and the tensioning element, and/or the tensioning element. The spring element can be relieved when the tensioning device does not exert the pressure force. When, however, the tensioning element presses on the spring element as intended and the pressure plate bears against the fuel cell stack, the spring element can be tensioned in between the pressure plate and the tensioning element. The spring element is preferably received at least in portions in the pressure plate. For this purpose, a second depression can be configured in the pressure plate. This second depression can be configured, in particular, as a cylindrically symmetrical blind hole. Moreover, the second depression can be dimensioned in such a way that the portion, received therein, of the spring element can be moved, in particular can be loaded and relieved without an external action of force, without being blocked by side walls of the second depression. Moreover, it is conceivable that the tensioning element is dimensioned in such a way that it fits at least in portions into the blind hole. Moreover, the at least one spring element can be received at least in portions in the base portion of the tensioning element.

In one preferred variant, the spring element is plugged into the pressure plate, and the tensioning element is plugged onto the spring element. The spring element is therefore advantageously connected in a positively locking manner to the pressure plate and/or (via the guide) to the tensioning element. Moreover, it is conceivable that, in the region of its end which faces the pressure plate, the spring element is additionally connected in a non-positive or integrally joined manner to the pressure plate. The pressure plate can be arranged in a centered manner on the second end (the longitudinal end which faces the contact surface) of the fuel cell stack.

The tensioning device of the tensioning system can be configured such that it can be screwed along the spring axis. For this purpose, the tensioning device can have a thread which is preferably configured coaxially with respect to the spring element. That is to say, a rotational axis of the tensioning device/thread preferably runs in a co-linear manner with respect to the spring axis. Other conceivable tensioning devices are, for example, snap rings which are inserted into pre-manufactured grooves, or beaded material which fixes the tensioning element on the housing and can therefore transmit the pressure force to the housing.

The fuel cell assembly proposed herein comprises a housing with a bottom part and a cover part, a fuel cell stack, and a tensioning system which is described in detail above. Here, the fuel cell stack is tensioned between the bottom part and the cover part by means of the tensioning system. In particular, the fuel cell stack can be tensioned between the bottom part and the pressure plate. Here, the pressure plate can be supported on the cover part by the spring element, the tensioning element and the tensioning device (preferably in the stated order).

The fuel cell stack preferably comprises a plurality of electrically conductive separator plates which can be configured as monopolar plates or bipolar plates and can delimit individual cells of the fuel cell stack. Each individual cell comprises substantially a membrane electrode assembly which is described at the outset, which assemblies are arranged between two of the separator plates. The separator plates and the membrane electrode assemblies are preferably oriented parallel to one another and are stacked in the stack direction along the spring axis. At least one sealing element can be tensioned between adjacent individual cells of the fuel cell stack in each case. The separator plates comprise through openings which, together with the sealing elements, configure a line for an operating medium of the fuel cells (for example, fuel, oxidizing agent or coolant). The fuel cell stack has, at its first end which faces the bottom part of the housing, a first current collector and, at its opposite second end which faces the pressure plate, a second current collector. The first and the second current collectors are preferably metallic, for example produced from copper or aluminum.

The bottom part of the housing is preferably configured as a plate which is oriented transversely with respect to the stack direction of the fuel cell stack. Here, the bottom part can be configured as what is known as a media pressure plate which can serve as an interface for passing through the operating medium into the fuel cell stack. The bottom part can have connectors for the fuel, the oxidizing agent and the coolant. The cover part of the housing is preferably not configured as a plate, but rather as a hood which delimits an interior region of the fuel cell assembly, in which the fuel cell stack is arranged. Here, the hood is preferably configured in one piece, in particular without joints (monolithically) and/or as a cast part. The bottom part and the cover part preferably together form the entire housing. As a consequence, the interior region can be sealed in a liquid-tight or gas-tight manner with respect to the surroundings of the fuel cell assembly, in particular by means of the housing and/or the tensioning element.

In one preferred variant, the housing (when the bottom part is connected to the cover part) has a hole which is preferably configured as a threaded bore with an internal thread and/or is arranged coaxially with respect to the spring element. The pressure plate can be arranged between the fuel cell stack and the hole. In this case, the tensioning device advantageously comprises the abovementioned nut which can be provided with an external thread which corresponds with the internal thread. The nut can therefore be received in a screwable manner in the hole/threaded bore. Accordingly, the tensioning element can be pressed axially along the spring axis in the direction of the fuel cell stack by way of screwing of the nut in the direction of the fuel cell stack, in particular via a direct contact between the nut and the tensioning element. It is also conceivable here that the tensioning element has an external thread and at least assists the function of the tensioning device (in particular, nut).

The elevation of the tensioning element can protrude at least in portions into the hole. In particular, the elevation can bear in a sealing manner against the housing, preferably against an inner peripheral surface of the hole. This makes it possible in a synergistic way for the interior region to be sealed with respect to the surroundings at the hole simply and efficiently.

The vehicle proposed herein is provided with a tensioning system described in detail above or a fuel cell assembly likewise described above. The fuel cell assembly can serve to supply vehicle electronics and/or a drive motor of the vehicle (directly or indirectly) with power.

By means of the method proposed herein, a fuel cell assembly, in particular the above-described fuel cell assembly, can be produced. This method can proceed in a fully automated or partially automated manner. It comprises the following steps which can be carried out, in particular, in the following order: providing the housing with the bottom part and the cover part; providing the fuel cell stack on the bottom part; positioning the pressure plate on that side of the fuel cell stack which is opposite the bottom part, with the result that the contact surface of the pressure plate bears against the fuel cell stack; arranging the tensioning element on that side of the pressure plate which is opposite the contact surface; arranging at least one spring element between the pressure plate and the tensioning element; pressing (axial pushing) of the pressure plate in the direction of the fuel cell stack by means of the tool, wherein the at least one spring element is preferably loaded along its spring axis; closing the housing, wherein the cover part is connected to the bottom part; providing a tensioning device; and removing the tool. Here, after the step of removing the tool, the tensioning device exerts the pressure force on the tensioning element, which pressure force is directed along the spring axis and in the direction of the pressure plate. The tensioning element transmits the pressure force via the preloaded at least one spring element to the pressure plate. The above-described fuel cell assembly is preferably therefore completed as soon as the tool no longer acts on the pressure plate.

As explained above, the bottom part can (also) be configured as a plate. Providing the fuel cell stack can comprise configuring (stacking) it fuel cell for fuel cell directly on the bottom part. In particular, a current collector can first of all be arranged on the bottom part. An end-side separator plate, in particular a monopolar plate, can then be configured on the current collector. Subsequently, the membrane electrode assembly can be positioned on the separator plate, and a further separator plate can be positioned on the membrane electrode assembly. These two steps can then be repeated multiple times until the fuel cell stack has its predetermined number of fuel cells.

In order for it to be possible for the stacking of the separator plates and the membrane electrode assemblies to be automated in an improved manner, the separator plates and/or the membrane electrode assemblies can each have at least one notch on their contours. Accordingly, the step of providing the fuel cell stack can comprise providing at least one rail which extends parallel to the stack direction, and bringing the rail into engagement with the notches. Toward the end of the step of providing the fuel cell stack, the latter can be provided at its second end with the second current collector.

During the steps of positioning the pressure plate, arranging the tensioning element and/or arranging the spring element between the pressure plate and the tensioning element, the at least one rail can remain on the fuel cell stack, in order to also orient the pressure plate relative to the fuel cell stack. The contact surface of the pressure plate can correspondingly lie practically over its full area on an inner surface facing the pressure plate at the second end of the fuel cell assembly. Arranging the spring element (including the guide) can comprise inserting the spring element at least in portions in the depression of the pressure plate, wherein the spring element remains axially movable. Arranging the tensioning element can comprise plugging the tensioning element onto the guide. Before the step of pressing the pressure plate, the spring element can be in its relieved starting state.

During subsequent pressing of the pressure plate, the pressure plate can be pressed by means of the at least one ram axially along the spring axis in the direction of the bottom part and can preferably be moved in the process. The ram can be arranged here to press coaxially with respect to the spring element. The pressure plate can be pressed directly, in particular with direct contact between the ram and the pressure plate, or indirectly via the spring element and the tensioning element. If the pressure plate is pressed indirectly via the spring element and the tensioning plate, it can be provided that the spring element is designed for loading by the pressing, or the tensioning plate is fixed (mechanically) on the pressure plate, for example screwed to it. In the latter case, the spring element is not subjected to any additional force by the pressing. Rather, the load path can run from the ram via the fixing directly to the pressure plate. The fixing can be released through the housing. The force during pressing can be in part higher than the pressure force (after assembly). The at least one spring element can be braced in the housing via the tensioning device to system pressure (pressure force).

During the pressing by means of the tensioning element, the respective receptacle of the tensioning element, into which the respective ram engages, can remain continuously arranged coaxially with respect to the spring element, with respect to the guide and/or with respect to the depression in the pressure plate. In both abovementioned cases, the pressing preferably takes place with force regulation, that is to say the respective ram is successively moved coaxially relative to the associated tensioning device (on the spring axis) until a predefined force, by way of which the ram presses on the pressure plate or the tensioning element, is achieved. This predefined force defines an assembly state, in which the cover part and the bottom part can be connected, in particular screwed, to one another. The predefined force can be greater than or as great as the above-described pressure force. Accordingly, the fuel cell stack can be compressed in the assembled state to a precisely pronounced extent as, or to a more pronounced extent than, in its final state after completion of the fuel cell assembly. If a plurality of rams are provided, they can be moved at the same time, at the same speed and/or parallel to one another.

The at least one ram preferably extends through the hole which is configured in the housing, in particular in the cover part of the housing, and is assigned to the respective ram. Here, the cover part can be mounted axially displaceably on the ram. In the step of closing the housing, the cover part can then be connected to the bottom part (in a positively locking, non-positive and/or integrally joined manner). In one preferred variant, the cover part is moved along the ram and axially, and is brought into contact with the bottom part. Here, the wall of the receptacle can slide along the inner wall of the hole. Subsequently, the bottom part and the cover part can be screwed to one another.

In one particularly preferred variant, each ram of the tool can be rotated about its longitudinal axis and/or about the spring axis. Each ram preferably engages, during the pressing of the pressure plate/tensioning element, into the tensioning device which is assigned to it. The respective tensioning device which, in particular, is configured as a nut and is received in the hole can therefore advantageously be screwed in situ in the direction of the fuel cell stack using the same tool/ram, by way of which the fuel cell stack is pressed against the bottom part. The ram can have a different shape, in particular, at its distal end than in its region which is in engagement with the tensioning device. For example, the distal end of the ram can be cylindrical with a round cross section. This cross section can have a diameter of between 10 mm and 30 mm. The cross section of the region which is in engagement with the tensioning device can be of polygonal, for example triangular, square, polygonal or hexagonal, configuration. The tensioning device/nut is preferably provided, in particular is screwed in, in such a way that it makes contact with the tensioning element. The system pressure (that is to say, the pressure force) can be set by way of this movement of the tensioning device in the direction of the spring element.

This makes it possible for the adjusted force to be maintained unchanged after completion of the fuel cell assembly, in particular after the step of removing the tool. As a result, a load path is set for pressing the fuel cell stack together, which load path runs from the pressure plate via the spring element and the tensioning element and the tensioning device/nut to the cover part, connected to the bottom part, of the housing.

In other words, the technology disclosed herein relates to a combination of a fuel cell housing and a bracing device which is suitable for the production of large quantities. Automation and process monitoring during the production can be realized. The process force load path is identical to the housing load path.

The bracing of the housing is provided via a bracing element (tensioning device) which makes it possible for a press ram to press the fuel cell stack via a direct load path. For example, a tensioning nut can be inserted into the housing. The tensioning nut (nut) can have an internal diameter which is greater than an external diameter of the ram. The transmission of force to the housing and the bracing of the spring element are realized via tightening of the tensioning nut. The assembly step, in which the tensioning nut is tightened, can be realized both via a rotation of the press ram and by way of a separately driven screwing aid. In order to reduce the weight/installation space, the system can also be realized in a single-part housing (without a tensioning cover). The transmission of force in the case of a large tensioning nut can be distributed comparatively uniformly over the cross-sectional area of the fuel cell stack.

The technology disclosed herein will now be explained on the basis of the appended figures.

### BRIEF DESCRIPTION OF THE DRAWINGS

FIG. 1 shows a fuel cell assembly with a tensioning system, wherein a fuel cell stack of the fuel cell assembly is pressed together by means of the tensioning system;

FIG. 2 shows the tensioning system of the fuel cell assembly from FIG. 1 in a detailed view;

FIGS. 3 to 9 show intermediate states of the fuel cell assembly from FIG. 1 during its production;

FIG. 10 shows the fuel cell assembly from FIG. 1 in a perspective detailed view of the cover part, wherein a plurality of rams for pressing the pressure plate are shown;

FIG. 11 shows the tensioning system of the fuel cell assembly from FIG. 1 in a detailed view, after the rams have been removed;

FIG. 12 shows a vehicle, in particular a motor vehicle, with the fuel cell assembly from FIG. 1; and

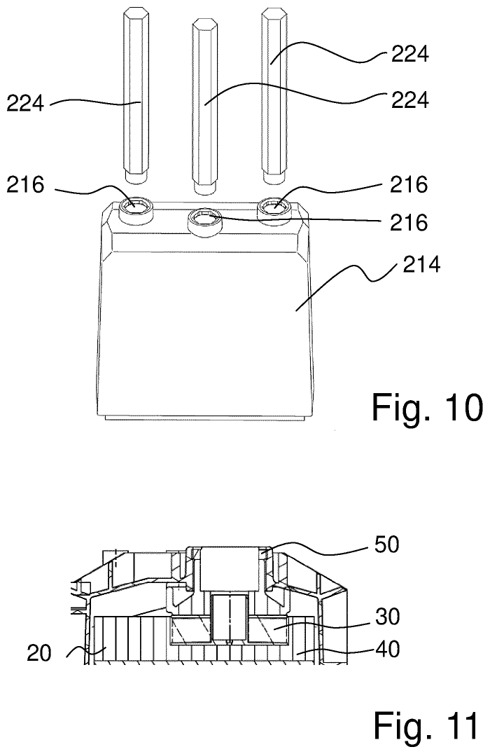

FIG. 13 shows a method for producing the fuel cell assembly from FIG. 1.

### DETAILED DESCRIPTION OF THE DRAWINGS

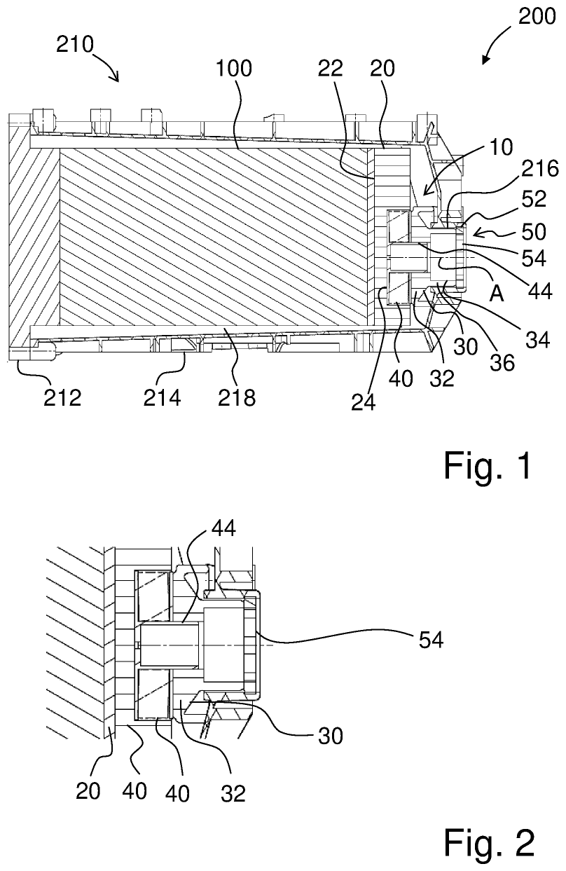

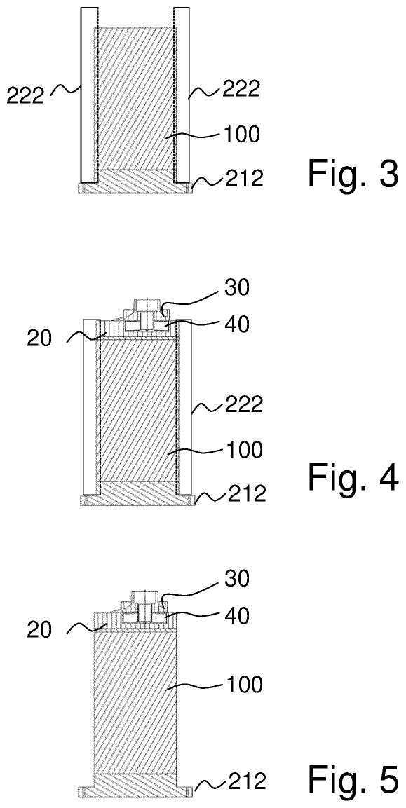

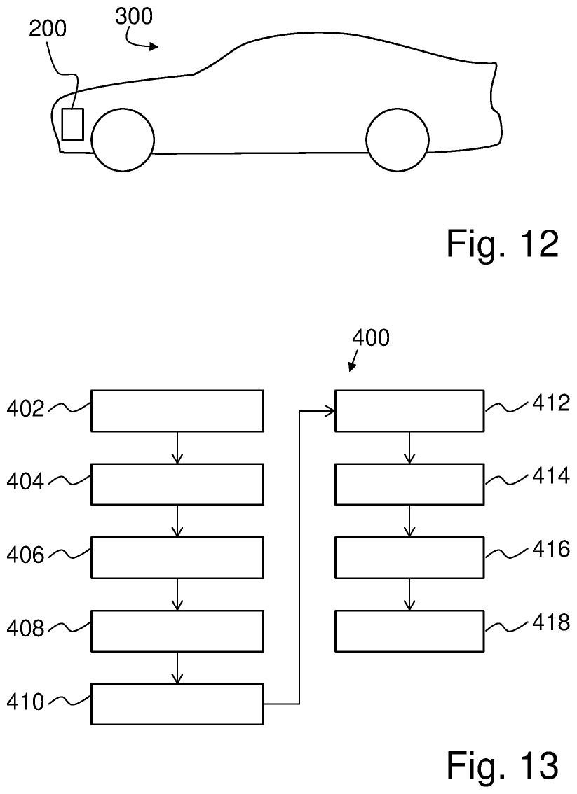

FIGS. 1 and 2 show a fuel cell assembly 200 which is provided for use in a vehicle 300 which is shown in FIG. 13. The vehicle 300 can be, for example, a passenger motor car. As an alternative, the vehicle 300 can be, for example, a watercraft or an aircraft.

The fuel cell assembly 200 comprises a housing 210 with a bottom part 212 and a cover part 214, a fuel cell stack 100, and a tensioning system 10. The housing 210 defines an internal region 218, in which the fuel cell stack 100 is arranged. The bottom part 212 of the housing 210 is configured as a plate (what is known as a media pressure plate). The cover part 214 of the housing 210 is configured as a hood and, at its end which is opposite the bottom part 212, has a hole 216 with an internal thread. The tensioning system 10 is configured to tension the fuel cell stack 100 between the bottom part 212 and the cover part 214. For this purpose, the tensioning system 10 is supported on its side which is opposite the fuel cell stack 100 on the cover part 214. At its end which faces the bottom part 212, the fuel cell stack 100 has a first current collector (not shown) and, at its end which faces the tensioning system 10, a second current collector.

The tensioning system 10 comprises a pressure plate 20, a tensioning element 30 which is configured here as a (tensioning) plate, a plurality of spring elements 40 which are tensioned between the pressure plate 20 and the tensioning element 30, and a plurality of tensioning devices 50 which are each assigned to a spring element 40 (as an alternative, to a set of spring elements 40 which lie on one another) and, in this variant, are each configured as a nut with an external thread 52. The external thread 52 of each nut is in engagement with the respective internal thread of the hole 216. The spring elements 40 are (in particular, structurally and functionally) identical. Each of the spring elements 40 is received at least in portions in a depression, belonging to it, in the pressure plate 20. In the following text, statements relating to one of the spring elements 40 (“the spring element 40”), one of the tensioning devices 50 (“the tensioning device 50”) and one of the depressions in the pressure plate 20 (“the depression”) apply mutatis mutandis to the remaining spring elements 40, tensioning devices 50 and depressions in the pressure plate 20, respectively.

The pressure plate 20 bears with its entire side which faces the fuel cell stack 100 via its contact surface 22 against the fuel cell stack 100. The pressure plate 20 is advantageously congruent with respect to an end surface, facing the pressure plate 20, of the fuel cell stack 100, even though the pressure plate 20 can protrude beyond the fuel cell stack 100 transversely in relation to the stack direction. Moreover, on its side which is opposite the fuel cell stack 100, the pressure plate 20 comprises a receptacle 24, in which the spring element 40 can be received or is received at least in portions.

The spring element 40 is positioned on a side of the pressure plate 20 which faces away from the fuel cell stack, and is configured in the present case as a set of cup springs which are stacked on one another in the stack direction of the fuel cell stack 100. As an alternative, for example, the spring element 40 can be configured as an elastic block made from a solid material. The spring element 40 has a spring axis A, along which the spring element 40 can be compressed (can be loaded) in its position in the receptacle 24 and can expand again automatically. Moreover, the spring element 40 is of cylindrically symmetrical configuration, wherein the spring axis A is the axis of symmetry of the spring element 40. Centrally and coaxially with respect to the set of the cup springs, a guide 44 extends through the set of the cup springs. The guide 44 is configured as a cylindrical tubular portion and, in the present case, in one piece and without joints with the set of cup springs. The guide 44 advantageously extends as far as into a depression which is configured in the tensioning element 30, in particular in a base portion 32 of the tensioning element 30.

On its side which is opposite the pressure plate 20, the tensioning element 30 has a receptacle 34 for a ram 224 of a tool. The receptacle 34 is configured as a hole with a round cross section, preferably as a blind hole, which is open toward that side of the tensioning element 30 which is opposite the fuel cell stack 100. The hole 216 and the spring element 40 run coaxially with respect to one another, that is to say the spring axis A is an axis of symmetry of the hole 216. At its end which is opposite the spring element 40, the tensioning element 30 is mounted axially on the tensioning device along the entire edge of the receptacle 34. Via this mounting, the tensioning device 50 exerts a pressure force on the tensioning element 30 which is directed along the spring axis A in the direction of the pressure plate 20. The tensioning element 30 is therefore configured to transmit the pressure force to the pressure plate 20 with preloading of the at least one spring element 40.

The tensioning device 50, the receptacle 34 and the spring element 40 are oriented coaxially (in relation to the spring axis) with respect to one another, with the result that the pressure force is transmitted precisely and in a straight line from the tensioning device 50 (nut) to the pressure plate 20. This pressure force can be set by way of screwing in/out of the nut 54. The guide 44 and the depression of the tensioning element 30 are likewise oriented coaxially with respect to one another and with respect to the tensioning device 50, the receptacle 34 and the spring element 40. A surface of the base portion 32 which faces the pressure plate 20 and by way of which the tensioning element 30 makes contact with the spring element 40 is advantageously planar. In the present variant, the receptacle 34 is configured as a cylindrically symmetrical depression, and the spring axis A is an axis of symmetry of the receptacle 34.

The pressure plate 20 is advantageously rigid, in particular more rigid than the spring element 40. The tensioning element 13 can have one elevation 36 per receptacle 34, in which elevation the receptacle 34 is configured. An end of the elevation 36 which faces away from the pressure plate 20 can protrude into the hole 216 and can bear in a sealing manner against the wall of the hole 216. For this purpose, this end can be elastic. The tensioning element 30 can therefore seal, both per se or in combination with the spring element 40, the interior region 218 with respect to the surroundings in a liquid-tight or gas-tight manner.

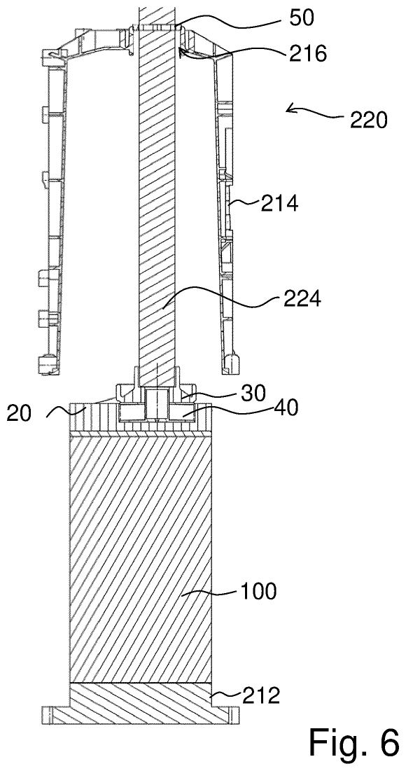

The fuel cell assembly 200 can be produced as shown in a step-by-step fashion in FIGS. 3 to 11. With regard to the individual steps 402 to 416 of the production method 400, reference is made to FIG. 13. In the following text, statements relating to a spring element 40 and the further components assigned to the spring element 40 (in particular, the tensioning device 50/nut and ram 224) apply mutatis mutandis to the remaining spring elements 40 and the corresponding further components. In particular, each spring element 40 is assigned a ram 224.

In a first step 402, the housing 210 with the bottom part 212 and the separate cover part 214 is provided. The fuel cell stack 100 is then produced directly on the bottom part 212 in step 404 (see FIG. 3). This takes place fuel cell for fuel cell, wherein the guide rails 222 (guide profiles) can be positioned on at least two side surfaces of the fuel cell stack 100, in order to stack the components of the fuel cell stack 100 on one another in an oriented manner. That is to say, a separator plate is preferably first of all positioned on the bottom part 212. A membrane electrode assembly is placed onto this separator plate, and subsequently a further separator plate is placed on top. This procedure is preferably repeated until the fuel cell stack 100 is complete.

In the next step 406, the pressure plate 20 is placed on a side of the fuel cell stack 100 which is opposite the bottom part 212, with the result that the contact surface 22 of the pressure plate 20 bears against the fuel cell stack 100. Subsequently, the spring elements 40 are inserted into the pressure plate 20 (step 410), and the tensioning element 30 is placed onto the spring elements 40. Here, the guide 44 passes into engagement with the depression in the base portion 32. As an alternative, the pressure plate 20, the spring elements 40 and the tensioning element 30 can be positioned in the assembled state on the fuel cell stack 100 (see FIG. 4). As shown in FIG. 5, the rails 22 can then be removed.

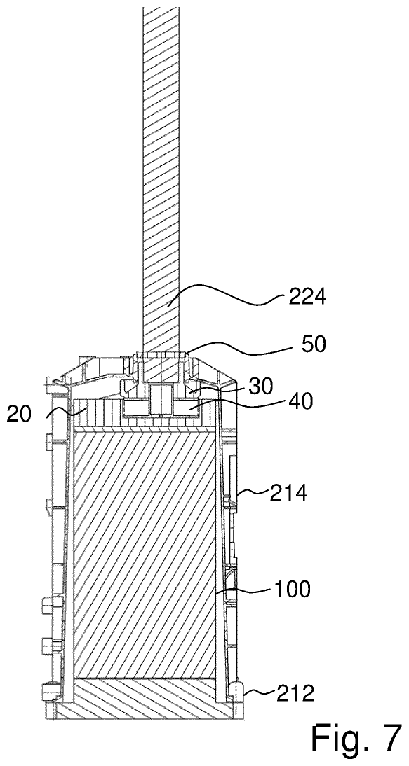

In a next step 412, the pressure plate 20 is pressed indirectly by means of the tensioning element 30 in the direction of the fuel cell stack 100 by means of a tool 220, in the present case a ram press (see FIG. 6). Here, each of the spring elements 40 is compressed along its spring axis A and is preloaded as a result. Here, rams 224 of the tool 220 pass through in each case one of the holes 216 of the housing 210 (cf. FIG. 10). That end of the (respective) ram 224 which faces the pressure plate 20 engages into the receptacle 34. This end is mounted in a sliding or rolling manner in the receptacle 34, in particular via an axial bearing. The (respective) ram 224 is oriented coaxially with respect to the nut and with respect to the receptacle 34.

The cover part 214 of the housing 210 is then moved axially in the direction of the bottom part 212, and the cover part 214 is connected, in particular screwed, to the bottom part 212, in order to close the housing 210 (see FIG. 7). Here, the elevation 36 passes into engagement with the hole 216. Moreover, in the state which is shown in FIG. 7, the ram 224 is in engagement with the nut, in order for it to be possible to screw the latter. The further step of providing 416 a tensioning device 50 can take place at the same time as providing 402 the housing or at the latest in the state which is shown in FIG. 7. A detailed view from FIG. 8 which illustrates the state of the tensioning system 10 according to FIG. 7 clarifies that the tensioning device 50 does not yet press on the tensioning element 30.

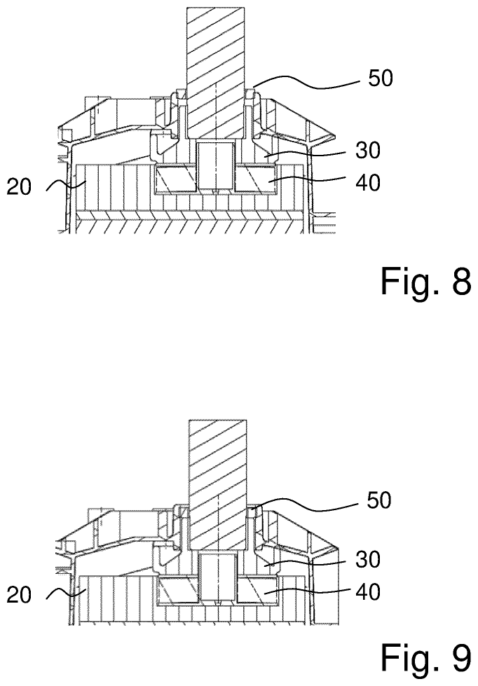

In order to conclude the production of the fuel cell assembly, it can be provided in step 416, moreover, that the ram is rotated about its own longitudinal axis (that is to say, the spring axis), in order that the nut is brought into contact with the tensioning element 30. As a result, the load path between the pressure plate 20 and the housing 210 is closed, and the ram 224 of the tool 220 can be removed as shown in FIG. 10 (step 418). After the step of removing 418 the tool 220, the tensioning device 50/nut can therefore exert the pressure force on the tensioning element 30. This pressure force is directed along the spring axis A and in the direction of the pressure plate 20, and is transmitted from the tensioning element 30 via the now preloaded (as shown in FIG. 11) spring element 40 to the pressure plate 20.

For reasons of legibility, the expression “at least one” is partially omitted in this disclosure in a simplifying manner. If a feature of the technology disclosed herein is described in the singular or indefinite form (for example, a/the spring element, a/the tensioning device, a/the ram, a/the receptacle (for the ram), etc.), a plurality thereof is also intended to be disclosed at the same time (for example, the at least one spring element, the at least one tensioning device, the at least one ram, the at least one receptacle (for the ram), etc.). Here, at least in portions means in portions or completely. Within the context of the technology disclosed herein, the term “substantially” in each case includes the precise property or the precise value and deviations which are insignificant in each case for the function of the property/value, for example on account of manufacturing tolerances.

The preceding description of the present invention serves merely for illustrative purposes and not for the purpose of restricting the invention. Different amendments and modifications are possible within the context of the invention without departing from the scope of the invention and its equivalents.

1.-15. (canceled)

16. A tensioning system for a fuel cell stack, comprising:
a pressure plate with a contact surface for bearing against the fuel cell stack;
a tensioning element which is arranged on a side of the pressure plate which is opposite the contact surface;
at least one spring element which is arranged between the pressure plate and the tensioning element and has a spring axis, along which the at least one spring element is tensionable; and
at least one tensioning device,
wherein the tensioning device is configured to exert a pressure force on the tensioning element,
wherein the pressure force is directed along the spring axis and in a direction of the pressure plate, and
wherein the tensioning element is configured to transmit the pressure force to the pressure plate with preloading of the at least one spring element.

17. The tensioning system according to claim 16, wherein
the tensioning device is arranged coaxially with respect to the at least one spring element, and/or
the at least one spring element has a cup spring or a spiral spring.

18. The tensioning system according to claim 16, wherein the tensioning element is configured as a sleeve or as a plate.

19. The tensioning system according to claim 16, wherein
the at least one spring element is provided with a guide,
the guide is received in the tensioning element, and
the tensioning element is movable along the guide coaxially with respect to the spring axis.

20. The tensioning system according to claim 16, wherein
the tensioning element has at least one receptacle, and
the receptacle is open toward a side of the tensioning element which is opposite the pressure plate.

21. The tensioning system according to claim 20, wherein
the receptacle is configured as a cylindrically symmetrical depression, and
the spring axis is an axis of symmetry of the receptacle.

22. The tensioning system according to claim 16, wherein
wherein the tensioning device is provided with a thread and/or is screwable along the spring axis.

23. The tensioning system according to claim 16, wherein
the tensioning element has a base portion which is provided to make contact with the at least one spring element, and
a surface of the base portion which faces the pressure plate is planar.

24. The tensioning system according to claim 16, wherein
the at least one spring element is received at least in portions in the pressure plate and/or the tensioning element.

25. A fuel cell assembly, comprising:
a housing with a bottom part and a cover part;
a fuel cell stack; and
a tensioning system according to claim 16,
wherein the fuel cell stack is clamped in between the bottom part and the cover part via the tensioning system.

26. The fuel cell assembly according to claim 25, wherein
the housing has at least one hole,
the pressure plate is arranged between the fuel cell stack and the hole, and
the tensioning device comprises at least one nut which is received in a screwable manner in the hole.

27. The fuel cell assembly according to claim 26, wherein
the tensioning element has at least one elevation which protrudes at least in portions into the hole.

28. The fuel cell assembly according to claim 27, wherein
the housing defines an inner region, in which the fuel cell stack is arranged, and
the inner region is sealed with respect to surroundings of the housing via the tensioning element.

29. A vehicle comprising a fuel cell assembly according to claim 25.

30. A method for producing a fuel cell assembly, the method comprising the steps of:
providing a housing with a bottom part and a cover part;
providing a fuel cell stack on the bottom part;
positioning a pressure plate on a side of the fuel cell stack which is opposite the bottom part, with a result that a contact surface of the pressure plate bears against the fuel cell stack;
arranging a tensioning element on a side of the pressure plate which is opposite the contact surface;
arranging at least one spring element between the pressure plate and the tensioning element;
pressing the pressure plate in a direction of the fuel cell stack by use of a tool;
closing the housing, wherein the cover part is connected to the bottom part;
providing a tensioning device; and
removing the tool,
wherein the tensioning device exerts a pressure force on the tensioning element after the step of removing the tool,
wherein the pressure force is directed along a spring axis of the at least one spring element and in the direction of the pressure plate, and
wherein the tensioning element transmits the pressure force via the at least one spring element to the pressure plate.
